(19) United States
(12) Patent Application Publication
(10) Pub. No.: US 2014/0126247 A1
(43) Pub. Date: May 8, 2014

(54) SNUBBER CIRCUIT FOR DC-DC VOLTAGE CONVERTER

(71) Applicant: ROBERT BOSCH GMBH, Stuttgart (DE)

(72) Inventors: Stefan Koch, Kappelrodeck (DE); Jian Tian, Buehl (DE)

(73) Assignee: ROBERT BOSCH GMBH, Stuttgart (DE)

(21) Appl. No.: 14/122,362

(22) PCT Filed: Apr. 3, 2012
(86) PCT No.: PCT/EP12/56021

§ 371 Date: Jan. 2, 2014

(30) Foreign Application Priority Data
May 27, 2011 (DE) 102011076573.5

(51) Int. Cl. H02M 3/335

(52) U.S. Cl. CPC H02M 3/33507
USPC 363/21.14

(57) ABSTRACT

The invention relates to a DC-DC voltage converter (1), having a transformer (2) having a primary winding (2a) and a secondary winding (2b, 2c) having a centre tap, an output inductor (3), which is connected to the centre tap and to a first output connection (9a), a synchronous rectifier circuit (4) having two synchronous rectifier switches (14a, 14b), each of which is connected to the terminal taps of the secondary winding (2b, 2c), and which are designed to produce a rectified output voltage on a second output connection (9b), and a snubber circuit (5) that is switched by means of the synchronous rectifier circuit (4). In this case, the snubber circuit has two diodes (16a, 16b), each of which is coupled to the terminal taps of the secondary winding (2b, 2c), a capacitor (6), which is coupled to the two diodes (16a, 16b) and which is designed to store resonant oscillation energy arising in the synchronous rectifier circuit (4), and a discharge circuit (7) comprising a series circuit containing a discharge switch (18) and a resistor (17), wherein the discharge circuit (7) is coupled between the first output connection (9a) and the capacitor and is designed to selectively feed back stored charge in the capacitor (6) to the first output connection (9a).

### BACKGROUND OF THE INVENTION

The invention relates to a snubber circuit for a DC-DC voltage converter, in particular for a neutral point rectifier with synchronous rectification.

Synchronous rectifier circuits are usually used for DC-DC voltage conversion, for example for the purpose of supplying a low-voltage electrical system of a vehicle. The power semiconductor switches, for example MOSFETs, used for this purpose currently have a lower voltage loss than diodes at relatively high direct currents, as a result of which the efficiency of the rectifier can be increased. The output capacitance of semiconductor switches which are turned off may result, in the case of electrically decoupled synchronous rectifiers, in the phenomenon of “secondary ringing”, that is to say the occurrence of unwanted oscillations of the current or voltage. In this case, resonance is effected between the leakage inductance of the secondary side of the transformer with the secondary-side inductance and the output capacitance of the semiconductor switches.

Therefore, conventional synchronous rectifiers have attenuators, so-called “snubber elements”, which charge the oscillation energy of the oscillations to a capacitance if a critical voltage limit is exceeded. Passive snubber elements may consist of, for example, a series circuit comprising a capacitor and a resistor which can be connected in parallel with the semiconductor switch as an RC quenching combination. In contrast, active snubber elements have, in addition to the capacitor, a further semiconductor switch which can be used to discharge the excess charge, for example back into the secondary-side vehicle electrical system, if a critical amount of charge in the capacitor is exceeded.

The document U.S. Pat. No. 6,771,521 B1 discloses an active snubber circuit for a synchronous rectifier with a damping capacitor which can be discharged in a switchable manner via a semiconductor switch.

The document U.S. Pat. No. 5,898,581 discloses a neutral point rectifier circuit having an active snubber circuit, oscillation charge stored in a snubber capacitor being able to be fed back into the rectifier circuit via an inductive element.

Conventional snubber circuits, for example those disclosed in the document U.S. Pat. No. 5,898,581, are designed for high voltages or high energies in order to keep power losses low (so-called “lossless snubber”). In particular, the inductive components such as snubber inductors which are usually used in buck converters are associated with high unit costs since the components themselves are expensive and also give rise to high production costs during mounting.

### SUMMARY OF THE INVENTION

According to one embodiment, the present invention provides a DC-DC voltage converter having a transformer with a primary winding and a secondary winding with a center tap, an output inductance which is connected to the center tap and to a first output connection, a synchronous rectifier circuit with two synchronous rectifier switches which are each connected to the terminal taps of the secondary winding and are designed to produce a rectified output voltage at a second output connection, and a snubber circuit which is connected via the synchronous rectifier circuit. In this case, the snubber circuit has two diodes which are each coupled to the terminal taps of the secondary winding, a capacitor which is coupled to the two diodes and is designed to store resonant oscillation energy in the synchronous rectifier circuit, and a discharge circuit consisting of a series circuit comprising a discharge switch and a resistor, the discharge circuit being coupled between the first output connection and the capacitor and being designed to selectively feed stored charge in the capacitor back into the first output connection.

One concept of the present invention is to provide a snubber circuit for a DC-DC voltage converter which can be produced in a simpler and more cost-effective manner in the case of applications in which power losses are negligible on account of the low energy during secondary ringing and reverse recovery. For this purpose, inductive components such as a snubber inductor of an active snubber circuit are replaced with a current-limiting resistor. The power losses in this resistor are negligible with respect to the efficiency.

Another concept of the present invention is to dispense with a freewheeling diode in the feedback path of the capacitor since no inductive components are used.

### BRIEF DESCRIPTION OF THE DRAWINGS

Further features and advantages of embodiments of the invention emerge from the following description with reference to the accompanying drawings.

In the drawings:

FIG. 1 shows a schematic illustration of a DC-DC voltage converter according to one embodiment of the invention, and

FIG. 2 shows a schematic illustration of a DC-DC voltage converter according to another embodiment of the invention.

### DETAILED DESCRIPTION

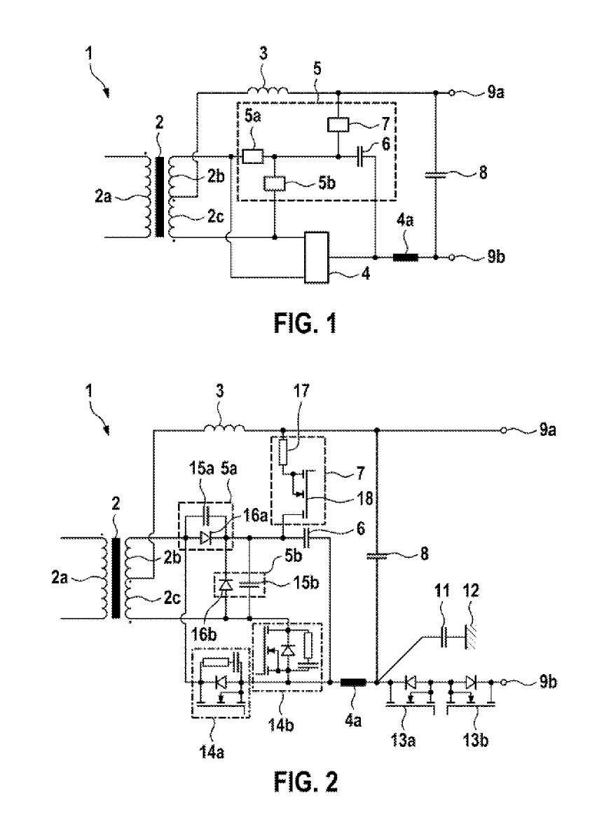

FIG. 1 shows a schematic illustration of a DC-DC voltage converter 1. The DC-DC voltage converter 1 comprises a transformer 2 with a primary winding 2a and a secondary winding which is divided into two sections 2b and 2c via a center tap. The transformer 2 may be designed, for example, to convert a high voltage into a low voltage and may have, for example, a winding ratio of the primary winding to the secondary winding of more than one, in particular 10:1, for example. The winding ratio of the two secondary winding sections 2b and 2c may not be equal to one. In particular, the winding ratio may be one in this case, that is to say the two secondary winding sections 2b and 2c have the same number of windings.

In this case, the center tap is connected to a first output connection 9a via a secondary-side inductance 3. The two terminal taps of the respective secondary winding sections 2b and 2c are connected, on the one hand, to two inputs of a synchronous rectifier circuit 4 and, on the other hand, to two inputs of an active snubber circuit 5. In this case, the DC-DC voltage converter 1 implements a neutral point rectifier circuit with active synchronous rectification.

The synchronous rectifier circuit 4 is designed to tap off a voltage applied to the secondary side of the transformer 2 from the terminal taps of the respective secondary winding sections 2b and 2c and to convert said voltage into a DC voltage at a second output connection 9b by means of a suitable connection. In other words, a DC output voltage can be tapped off between the output connections 9a and 9b during operation of the DC-DC voltage converter 1.

A shunt resistor 4a, at which the output current toward the second output connection 9b can be measured, can also be provided between the synchronous rectifier circuit 4 and the second output connection 9b. A DC voltage intermediate circuit 8 which can be used for the voltage smoothing can also be provided between the first and second output connections 9a, 9b.

The snubber circuit 5 has two snubber elements 5a and 5b which are each connected to the terminal taps of the secondary winding 2b, 2c of the transformer 2. The snubber elements 5a and 5b are designed to intercept voltage spikes which may occur at the inputs of the synchronous rectifier circuit 4 and to output them to a snubber capacitor or capacitor 6. The secondary winding 2b, 2c has a leakage inductance, as a result of which voltage oscillations, so-called “secondary ringing”, can occur between the output capacitance of the elements of the synchronous rectifier circuit 4 and the leakage inductance. The oscillation energy occurring in the process is stored in the capacitor 6 if a predetermined voltage across the snubber elements 5a and 5b is exceeded. The capacitor 6 may be implemented, for example, using a particular number of capacitors connected in parallel, for example six ceramic capacitors connected in parallel.

If the capacitor 6 has received a predetermined amount of charge, that is to say if the voltage applied to the capacitor 6 has exceeded a predetermined threshold value, the energy stored in the capacitor 6 can be fed back into the DC-DC voltage converter 1 in a controlled manner via a discharge circuit 7. In this case, the feedback via the discharge circuit can preferably be effected during a period of time during which the synchronous rectifier circuit 4 is in a freewheeling state.

FIG. 2 shows a DC-DC voltage converter 1 according to FIG. 1 in greater detail. In this case, the DC-DC voltage converter 1 may have a circuit-breaker 13a between the DC voltage intermediate circuit 8 and the second output connection 9b, which circuit-breaker is designed to disconnect the DC-DC voltage converter 1 from a connected low-voltage network. In this case, the circuit-breaker 13a may be constructed from two field effect transistors, for example. The DC-DC voltage converter 1 also comprises a polarity reversal protection switch 13b which is designed to ensure protection against polarity reversal at the output connections 9a, 9b. In this case, the polarity reversal protection switch 13b may likewise be constructed from two field effect transistors, for example.

A connection to ground, for example to a housing 12, can be established at a node between the shunt resistor 4a and the circuit-breaker 13a via a capacitor 11 in order to ensure the electromagnetic compatibility of the DC-DC voltage converter 1.

In FIG. 2, the synchronous rectifier circuit 4 is implemented by means of two synchronous rectifier switches 14a and 14b. In this case, each of the synchronous rectifier switches 14a, 14b has an active switching element and a freewheeling diode connected in parallel with the latter. It is clear here that the freewheeling diode may be the parasitic diode of the active switching element itself when semiconductor switches are used. Provision may also be made for passive snubber elements to be provided in parallel with each switching element; for example, RC quenching combinations with a series circuit comprising a capacitor and a resistor may be provided in parallel with the active switching element and the freewheeling diode, as shown in FIG. 2.

The snubber circuit 5 respectively comprises, as snubber elements 5a and 5b, two parallel circuits each comprising a diode 16a and 16b and a capacitor 15a and 15b. Excess (oscillating) charge is discharged to the capacitor 6 via the diodes 16a, 16b if a threshold voltage is exceeded at the inputs of the synchronous rectifier switches 14a, 14b. If the voltage across the capacitor 6 exceeds a predetermined voltage value, the charge can be actively fed through a resistor 17 into the DC-DC voltage converter 1 via a discharge switch 18. On account of the low secondary-side voltages in the DC-DC voltage converter 1, the power losses in the current-limiting resistor 17 are negligible.

In an alternative embodiment, provision may be made for a diode (not illustrated) to be arranged between the resistor 17 and the node between the secondary inductance 3 and the first output connection 9a. Such a diode can be used to minimize interfering influences, for example voltage fluctuations of the low-voltage network, on the capacitor 6.

The discharge switch 18 can be controlled by discharging the capacitor 6 during the freewheeling phase of the active switching elements, that is to say the synchronous rectifier switches 14a and 14b. The typical period time of a snubber event at one of the synchronous rectifier switches 14a and 14b may be below 5 μs, for example. Furthermore, the transport of charge of the resonant oscillations to the capacitor 6 may be concluded after 1 μs, for example. The maximum discharge duration may therefore be 4 μs in a period of time between 1 μs and 5 μs after the synchronous rectifier switch 14a or 14b has been closed. During this period of time, the discharge switch 18 may be additionally opened under the condition that the voltage across the capacitor 6 exceeds a predetermined value, for example 10% of the voltage across the primary winding 2a of the transformer 2, in order to discharge the charge stored in the capacitor 6 to the first output connection 9a via the resistor 17 and possibly a freewheeling diode.

The synchronous rectifier switches 14a, 14b, the circuit-breakers 13a, 13b and the discharge switch 18 used may each have semiconductor switches, for example field effect transistors (FETs). In the embodiments shown, the semiconductor switches are each illustrated as normally off n-MOSFETs (n-conducting Metal Oxide Semiconductor Field-Effect Transistors, enhancement type), but it is likewise possible to provide other semiconductor switches in a corresponding form, for example in the form of IGBTs (Insulated Gate Bipolar Transistors), JFETs (Junction Field-Effect Transistors) or p-MOSFETs (p-conducting Metal Oxide Semiconductor Field-Effect Transistors).

1. A DC-DC voltage converter having: a transformer with a primary winding and a secondary winding with a center tap; an output inductance which is connected to the center tap and to a first output connection; a synchronous rectifier circuit with two synchronous rectifier switches which are each connected to the terminal taps of the secondary winding and are designed to produce a rectified output voltage at a second output connection; and a snubber circuit which is connected via the synchronous rectifier circuit and has: two diodes which are each coupled to the terminal taps of the secondary winding; a capacitor which is coupled to the two diodes and is designed to store resonant oscillation energy occurring in the synchronous rectifier circuit; and a discharge circuit consisting of a series circuit comprising a discharge switch and a resistor, the discharge circuit being coupled between the first output connection and the capacitor and being designed to selectively feed stored charge in the capacitor back into the first output connection.

2. The DC-DC voltage converter as claimed in claim 1, the discharge circuit also comprising a freewheeling diode connected in series with the resistor.

3. The DC-DC voltage converter as claimed in claim 1, the synchronous rectifier circuit also comprising two RC elements which are each connected in parallel with the two synchronous rectifier switches.

4. The DC-DC voltage converter as claimed in claim 1, the winding ratio of the primary winding to the secondary winding of the transformer being greater than one.
